(19) United States
(12) Patent Application Publication
(10) Pub. No.: US 2007/0159684 A1
(43) Pub. Date: Jul. 12, 2007

(54) Welding mask

(76) Inventor: Mario Roy, Evain (CA)

Correspondence Address: MUIRHEAD AND SATURNELLI, LLC, 200 FRIBERG PARKWAY, SUITE 1001, WESTBOROUGH, MA, 01581, US

(21) Appl. No.: 11/363,513

(22) Filed: Feb. 27, 2006

(30) Foreign Application Priority Data
Jan. 12, 2006 (CA) 2,532,698

(51) Int. Cl. F21V 9/06

(52) U.S. Cl. 359/361; 359/601

(57) ABSTRACT

A welding mask comprising a face shield for at least partially covering the face of a user. The face shield has a viewing portion made of opaque translucent material. The opaque material provides for high-intensity visible light associated with welding to be visible therethrough. Also disclosed herein is welding mask assembly comprising a principle mask as described above with either a protective outer layer or mask mounted thereto or an inner mask or shield mounted on the underside thereof or having both of the foregoing mounted thereto.

### CROSS-REFERENCE APPLICATIONS

The present application requests priority on Canadian Patent Application No. 2,532,698 filed on Jan. 12, 2006 and which is incorporated herein in its entirety.

### FIELD OF THE INVENTION

The present invention relates to welding masks. More specifically, the present invention is concerned with welding masks made of plastic material.

### BACKGROUND OF THE INVENTION

Welding is a fabrication process that joins materials, usually metals or thermoplastics, by causing coalescence. This is often done by melting the workpieces and adding a filler material to form a pool of molten material (the weld puddle) that cools to become a strong joint, but sometimes pressure is used in conjunction with heat, or by itself, to produce the weld. This is in contrast with soldering and brazing, which involve melting a lower-melting-point material between the workpieces to form a bond between them, without melting the workpieces. Many different. energy sources can be used for welding, including a gas flame, an electric arc, a laser, an electron beam, friction, and ultrasound. While often an industrial process, welding can be done in many different environments, including open air, underwater and in space. Regardless of location, however, welding remains dangerous, and precautions must be taken to avoid burns, electric shock, poisonous fumes, and overexposure to ultraviolet light. The intense light associated with welding can cause damage to the retina of the eye, while infrared radiation may damage the cornea and result in the formation of cataracts. Invisible ultraviolet light (UV) from the arc can cause “arc eye” or “welder's flash” after even a brief exposure (less than one minute). The symptoms of arc eye usually occur many hours after exposure to UV light, and include a feeling of sand or grit in the eye, blurred vision, intense pain, tearing, burning, and headache. The arc can reflect off surrounding materials and burn co-workers who work nearby. About half of welder's flash injuries occur in co-workers who are not welding. Welders and cutters who continually work around ultraviolet radiation without proper protection can suffer permanent eye damage. Exposure to ultraviolet light can also cause skin burns similar to sunburn, and increase the welder's risk of skin cancer. Visible light from welding processes is very bright and can overwhelm the ability of the iris of the eye to close sufficiently and rapidly enough to limit the brightness of the light reaching the retina. The result is that the light is temporarily blinding and fatiguing to the eye. A serious concern is the “blue light hazard” which is the temporary or permanent scarring of the retina due to its sensitivity to blue light, around 440 nm wavelength. Blindness may result.

Therefore, it is important for welders to protect their faces, eyes and skin. Hence, welding masks or welder's face shields are well-know in the art.

Various designs for welding masks which give a greater range of vision are taught in the art, for example, in U.S. Pat. No. 3,868,727 issued to Paschall on Mar. 4, 1975 which provides a welding hood and a face shield of transparent or translucent material which supports and surrounds a direct viewing area in order to provide a better peripheral viewing capability for the user. Protection from light of varied intensity and wavelengths is provided through the use of stepped multi layers of varied thicknesses of shade, lens material at positions coordinated with the user's line of sight.

Some drawbacks with prior art welding masks are the high cost thereof, the fact that they are not disposable, and the weight they exert on the head of the user.

There thus remains a need for an improved welding mask,

### OBJECTS OF THE INVENTION

An object of the present invention is to provide an improved welding mask.

### SUMMARY OF THE INVENTION

In accordance with an aspect of the present invention, there is provided a welding mask comprising a face shield for at least partially covering the face of a user, the face shield comprising a viewing portion thereof, the viewing portion comprising opaque translucent material, wherein the opaque material provides for high-intensity visible light associated with welding to be visible therethrough.

In an embodiment, the high-intensity visible light associated with welding comprises a light having a wavelength from about 400 nm to about 700 nm. In an embodiment, the opaque translucent material substantially blocks light wavelengths <400 nm. In an embodiment, the opaque translucent material substantially blocks light wavelengths >700 nm. In an embodiment, the opaque translucent material substantially blocks light wavelengths <400 nm and >700 nm and allows wavelengths between 400 nm-700 nm to be visible therethrough.

In an embodiment, the opaque translucent material is coated with a solar deflector material.

In an embodiment, the opaque material comprises a tinted polymeric material. In an embodiment, the tinted polymeric material comprises tinted plastic.

In an embodiment, the mask further comprises a protecting layer mounted on the viewing portion opaque material. In an embodiment, the protective layer comprises transparent material. In an embodiment, the protective layer comprises an auxiliary face shield mounted to the face shield. In an embodiment, the auxiliary face shield is pivotally mounted to the face shield. In an embodiment, the protective layer comprises an auxiliary mask mounted to the mask. In an embodiment, the auxiliary mask is pivotally mounted to the mask. In an embodiment, the mask further comprises lateral sides having mounting elements, the auxiliary mask comprising lateral sides having mounting elements, the mask mounting elements being pivotally mounted to the auxiliary mask mounting elements. In an embodiment, the face shield comprises an external side and an opposite face-mounting side, an auxiliary inner face shield being mounted on the face shield face mounting side. In an embodiment, auxiliary inner face shield comprises transparent material. In an embodiment, auxiliary inner face shield is pivotally mounted to the face shield. In an embodiment, the mask further comprises an external side and an opposite face-mounting side, an auxiliary mask being mounted on the mask ace mounting side. In an embodiment, the auxiliary mask comprises transparent material auxiliary mask is pivotally mounted to the mask. In an embodiment, the mask further comprises lateral sides having mountings elements, the auxiliary inner mask comprising lateral sides having mounting elements, the mask mounting elements being pivotally mounted to the auxiliary mask mounting elements.

In an embodiment, the face shield comprises an external side and an opposite face-mounting side, an auxiliary inner face shield being mounted on the face shield face mounting side. In an embodiment, the auxiliary inner face shield comprises transparent material. In an embodiment, the auxiliary inner face shield is pivotally mounted to the face shield.

In an embodiment, the mask further comprises an external side and an opposite face-mounting side, an auxiliary mask being mounted on the mask ace mounting side. In an embodiment, the auxiliary mask comprises transparent material. In an embodiment, the auxiliary mask is pivotally mounted to the mask. In an embodiment, the mask further comprises lateral sides having mountings elements, the auxiliary inner mask comprising lateral sides having mounting elements, the mask mounting elements being pivotally mounted to the auxiliary inner mask mounting elements.

In accordance with another aspect of the present invention there is provided a welding mask assembly comprising: a principle mask comprising a face shield for at least partially covering the face of a user, the face shield comprising a viewing portion thereof, the viewing portion comprising opaque translucent material, wherein the opaque material provides for high-intensity visible light associated with welding to be visible therethrough; and an auxiliary outer protective mask mounted on the principle mask.

In an embodiment, the mask assembly further comprises an auxiliary inner mask mounted to the underside of the principle mask.

In an embodiment, high-intensity visible light associated with welding comprises a light having a wavelength from about 400 nm to about 700 nm. In an embodiment, the opaque translucent material substantially blocks light wavelengths <400 nm. In an embodiment, the opaque translucent material substantially blocks light wavelengths >700 nm. In an embodiment, the opaque translucent material substantially blocks light wavelengths <400 nm and >700 nm and allows wavelengths between 400 nm-700 nm to be visible therethrough.

In an embodiment, the opaque translucent material is coated with a solar deflector material.

In an embodiment, the opaque material comprises. a tinted polymeric material. In an embodiment, the auxiliary outer protective mask comprises transparent material. In an embodiment, the auxiliary inner protective mask comprises transparent material.

In an embodiment, the auxiliary outer protective mask is pivotally mounted to the principle mask. In an embodiment, the principle mask comprises lateral sides having mountings elements, the auxiliary outer mask comprising lateral sides having mounting elements, the principle mask mounting elements being pivotally mounted to the auxiliary outer mask mounting elements.

In an embodiment, the auxiliary inner mask is pivotally mounted to the principle mask. In an embodiment, the principle mask comprises lateral sides having mountings elements, the auxiliary inner mask comprising lateral sides having mounting elements, the principle mask mounting elements being pivotally mounted to the auxiliary inner mask mounting elements.

In accordance with a further aspect of the present invention there is provided a welding mask assembly comprising: a principle mask comprising a face shield for at least partially covering the face of a user, the face shield comprising a viewing portion thereof, the viewing portion comprising opaque translucent material, wherein the opaque material provides for high-intensity visible light associated with welding to be visible therethrough; and an auxiliary inner protective mask mounted to the underside of the principle mask.

In an embodiment, the welding mask assembly further comprises an auxiliary outer protective mask mounted to the on the principle mask.

In an embodiment, the high-intensity visible light associated with welding comprises a light having a wavelength from about 400 nm to about 700 nm. In an embodiment, the opaque translucent material substantially blocks light wavelengths <400 nm. In an embodiment, the opaque translucent material substantially blocks light wavelengths >700 nm. In an embodiment, the opaque translucent material substantially blocks light wavelengths <400 nm and >700 nm and allows wavelengths between 400 nm-700 nm to be visible therethrough.

In an embodiment, the opaque translucent material is coated with a solar deflector material.

In an embodiment, the opaque material comprises a tinted polymeric material. In an embodiment, auxiliary inner mask comprises transparent material. In an embodiment, the auxiliary outer protective mask comprises transparent material.

In an embodiment, the auxiliary inner mask is pivotally mounted to the principle mask. In an embodiment, the principle mask comprises lateral sides having mountings elements, the auxiliary inner mask comprising lateral sides having mounting elements, the principle mask mounting elements being pivotally mounted to the auxiliary inner mask mounting elements.

In an embodiment, the auxiliary outer mask is pivotally mounted to the principle mask. In an embodiment, the principle mask comprises lateral sides having mountings elements, the auxiliary outer mask comprising lateral sides having mounting elements, the principle mask mounting elements being pivotally mounted to the auxiliary outer mask mounting elements.

The word “mask” should be construed herein to include, without limitation, a facial shield of any size or configuration and/or a facial shield of any size or configuration coupled to any type of head gear that can be used to mount the facial shield to a user's face.

Other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings, where like reference mumberals denote like elements throughout, and where::

FIG. 1 is a perspective view of a welding mask in accordance with an embodiment of the present invention

FIG. 2 is a perspective front view of a welding mask assembly in accordance with an embodiment of the present invention;

FIG. 3 is a perspective lateral view of a welding mask assembly in accordance with an embodiment of the present invention; and

FIG. 4 is a perspective rear exploded view of a welding mask assembly in accordance with an embodiment of the present invention.

### DESCRIPTION OF THE ILLUTRATIVE EMBODIMENTS

With reference to the associated drawings a welding mask in accordance with an embodiment of the present invention will now be described.

Welding arcs give off radiation over a broad range of wavelengths—from 200 nm (nanometres) to 1,400 nm (or 0.2 to 1.4 μm, micometres). This includes ultraviolet (UV) radiation (200 to 400 nm), visible light (400 to 700 nm), and infrared (IR) radiation (700 to 1,400 nm). The masks and mask assemblies of the invention block UV and IR radiation while allowing visible light to be visible to the user.

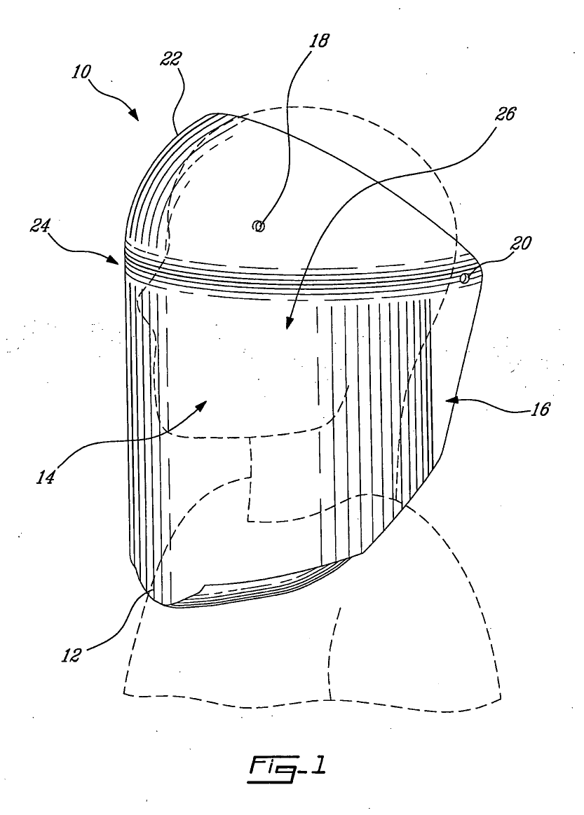

FIG.1 shows a welding mask 10 that is completely made of a tinted or opaque translucent material that can be provided in a variety of different thicknesses and tints and a variety of known synthetic, semi-synthetic polymerization products such as plastic for example. The type of material, configuration of the mask 10 and degree of opaqueness or tint will be decided by the person skilled in the art in order to meet specific mask criteria within the context of the present invention. The tinted plastic material used for the masks of the invention substantially block UV radiation and IR radiation.

Therefore it should be understood that the term “opaque translucent material” is a material that blocks light wavelengths less than (<)400 nm and greater than >700 nm while allowing wavelengths between 400 nm and 700 nm therethrough.

The mask 10 can also be coated with a solar deflector or light deflector material, as is understood by the skilled artisan, such as chrome or a color coating.

The mask 10 comprises a facial shield that has a bottom guard 12, lateral side shields 14 and 16 with mounting elements 18 and 20 in order to mount a strap or other head gear. The mask 10 also has a top covering portion 22, a viewing side 24 and an opposite user mounting side 26.

Of course, the welding mask 10 of the present invention can be provided in a variety of configurations and sizes as well as various types of suitable polymeric or plastic, tinted or opaque materials known to those having skill in the art.

When in operation, the bright or high-intensity visible light associated with welding as is known in the art, such as sparks or flashes, provide the user to see through the opaque material. The mask 10 also provides for the user to see any such bright visible light associated with welding within their peripheral vision.

The mask 10 is light and cost effective in terms of manufacture as well as disposable. After a few usages, the user may acquire a new face shield in order to attach to their desired head gear. The head gear (not shown) can also be made of a light plastic material, or it can be a strap.

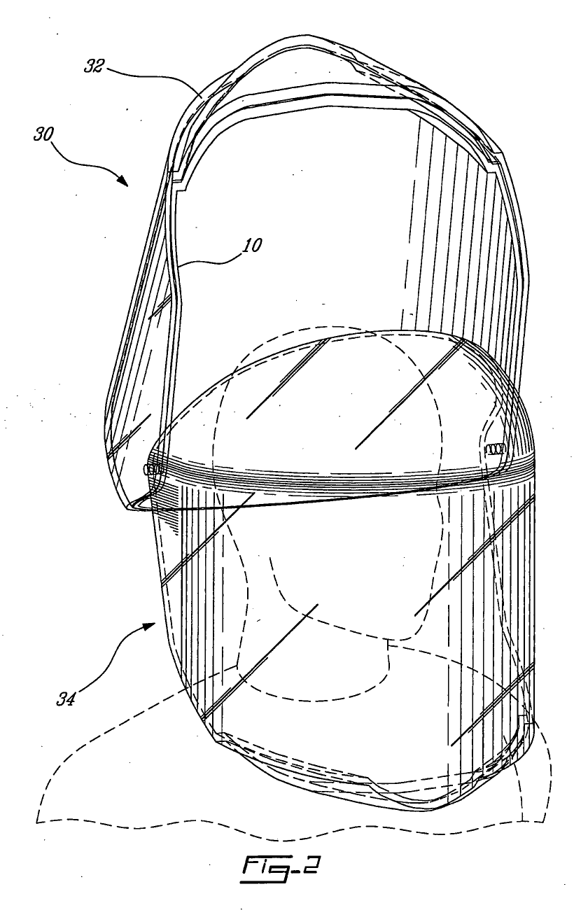

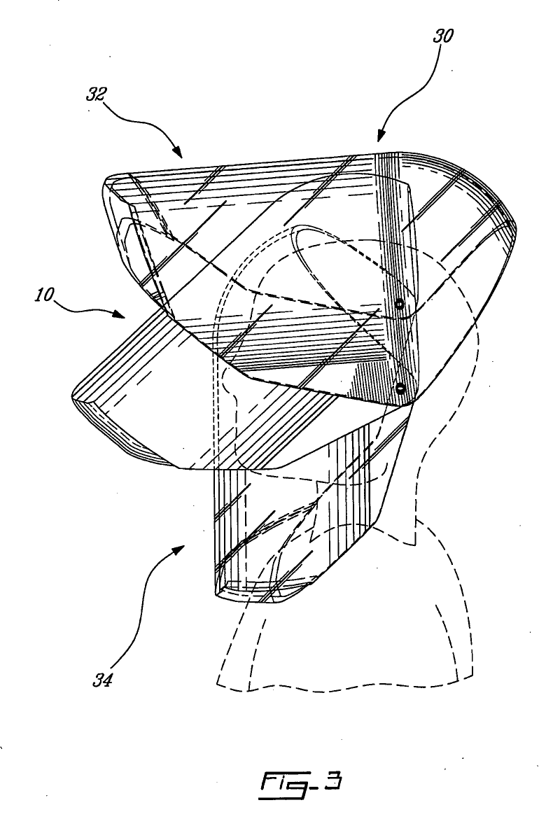

FIGS. 2, 3 and 4 show welding mask assembly 30 comprising three similarly constructed superimposed masks, namely auxiliary outer mask 32, auxiliary inner mask 34 and principle mask 10, as described above, therebetween.

Outer and inner masks 32 and 34 are made of transparent material such as synthetic or semi-synthetic material including plastic for example.

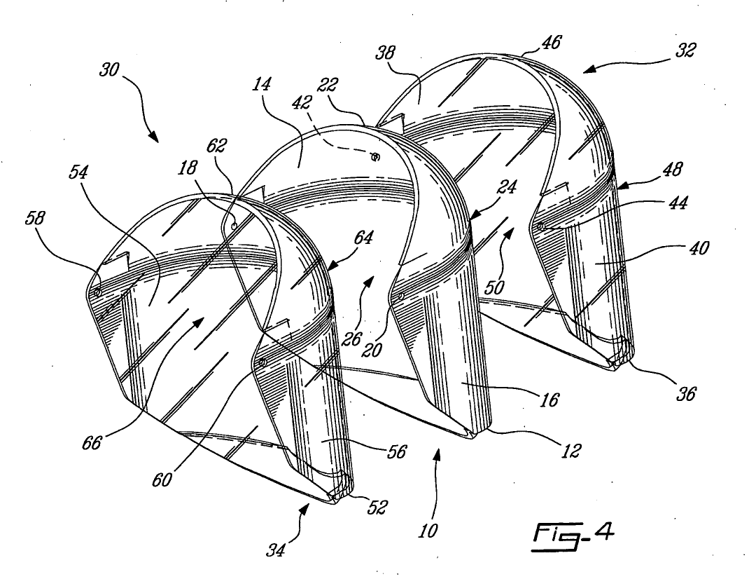

With particular reference to FIG. 4, outer mask 32 comprises a facial shield that has a bottom guard 36, lateral side shields 38 and 40 with mounting elements 42 and 44, a top covering portion 46, a viewing side 48 and an opposite user mounting side 50. Inner mask 34 comprises a facial shield that has a bottom guard 52, lateral side shields 54 and 56 with mounting elements 58 and 60, a top covering portion 62, a viewing side 64 and an opposite user mounting side 66.

The masks 32, 10 and 34 of the assembly 30 are pivotally mounted together at their coaxial mounting elements such as apertures 18, 42 and 58 and their coaxial mounting elements such as apertures 20, 44 and 60 via pivot members (not shown).

Straps or any other type of headgear may be mounted to the masks 32, 10 and 34 in a variety of ways known to the skilled artisan in order to securely mount the welding mask assembly 30 to the head of a user.

Furthermore, mask 32 is slightly larger than mask 10 which in turn is slightly larger than mask 34 thereby providing for mask 32 to be superimposed over mask 10 and mask 10 to be in turn superimposed over mask 34.

In operation, the outer mask 32 is a protective layer for mask 10. This protection allows for mask 10 to be used many times rather than just a few and then be recycled or discarded. When the outer protective mask 32 has been damaged it can be easily replaced. The inner mask 34 allows the user to pivot both mask 32 and 10 so as to protect the user while giving this user full view. This is useful during certain operations when the user needs full clear view but protection as well.

In another embodiment, only an outer protective mask and an opaque mask are provided. In a further embodiment, only an opaque mask and an inner transparent mask are provided.

It should be understood that masks 32, 10 and 34 can be provided in a variety of shapes, sizes and configurations. In one non-illustrated example, the masks of the welding mask assembly are face shields that are mounted to a headgear rather than full facial coverings.

The viewing portion of the masks of the present invention are the viewing sides such as 24, 48 and 64 of masks 10, 32 and 34 or the viewing area of face shield mounted or mountable to a head gear.

The opaque viewing portion, face shield or full mask may be produced by a variety of processes known in the art for tinting and molding plastic. The tint can comprise a variety of colors in order to give the masks a commercially desirable look or in order to meet specific criteria for particular welding masks.

It is to be understood that the invention is not limited in its application to the details of construction and parts illustrated in the accompanying drawings and described hereinabove. The invention is capable of other embodiments and of being practised in various ways. It is also to be understood that the phraseology or terminology used herein is for the purpose of description and not limitation.

Hence, although the present invention has been described hereinabove by way of embodiments thereof, it can be modified, without departing from the spirit, scope and nature of the subject invention as defined in the appended claims.

What is claimed is:

1. A welding mask comprising a face shield for at least partially covering the face of a user, said face shield comprising a viewing portion thereof, said viewing portion comprising opaque translucent material, wherein said opaque material provides for high-intensity light associated with welding to be visible therethrough.

2. A welding mask according to claim 1, wherein said high-intensity visible light associated with welding comprises a light having a wavelength from about 400 nm to about 700 nm.

3. A welding mask according to claim 1, wherein said opaque translucent material substantially blocks light wavelengths <400 nm and >700 nm.

4. A welding mask according to claim 1, wherein said opaque translucent material is coated with a solar deflector material.

5. A welding mask according to claim 1, wherein said opaque material comprises a tinted polymeric material.

6. A welding mask according to claim 5, wherein said tinted polymeric material comprises tinted plastic.

7. A welding mask according to claim 1, further comprising a protecting layer mounted on said viewing portion opaque material.

8. A welding mask according to claim 7 wherein said protective layer comprises transparent material.

9. A welding mask according to claim 7, wherein said protective layer comprises an auxiliary face shield mounted to said face shield.

10. A welding mask according to claim 9, wherein said auxiliary face shield is pivotally mounted to said face shield.

11. A welding mask according to claim 7, wherein said protective layer comprises an auxiliary mask mounted to said mask.

12. A welding mask according claim 11, wherein said auxiliary mask is pivotally mounted to said mask.

13. A welding mask according to claim 12, further comprising lateral sides having mountings elements, said auxiliary mask comprising lateral sides having mounting elements, said mask mounting elements being pivotally mounted to said auxiliary mask mounting elements.

14. A welding mask according to claim 1, wherein said face shield comprises an external side and an opposite face-mounting side, an auxiliary inner face shield being mounted on said face shield face mounting side.

15. A welding mask according to claim 14, wherein said auxiliary inner face shield comprises transparent material.

16. A welding mask according to claim 14, wherein said auxiliary inner face shield is pivotally mounted to said face shield.

17. A welding mask according to claim 1, further comprising an external side and an opposite face-mounting side, an auxiliary mask being mounted on said mask ace mounting side.

18. A welding mask according to claim 17, wherein said auxiliary mask comprises transparent material.

19. A welding mask according to claim 17, wherein said auxiliary mask is pivotally mounted to said mask.

20. A welding mask according to claim 29, further comprising lateral sides having mountings elements, said auxiliary inner mask comprising lateral sides having mounting elements, said mask mounting elements being pivotally mounted to said auxiliary inner mask mounting elements.

21. A welding mask assembly comprising:
a principle mask comprising a face shield for at least partially covering the face of a user, said face shield comprising a viewing portion thereof, said viewing portion comprising opaque translucent material, wherein said opaque material provides for high-intensity visible light associated with welding to be visible therethrough; and
an auxiliary outer protective mask mounted on said principle mask.

22. A welding mask assembly according to claim 21, further comprising an auxiliary inner mask mounted to the underside of said principle mask.

23. A welding mask assembly according to claim 21, wherein said high-intensity visible light associated with welding comprises a light having a wavelength from about 400 nm to about 700 nm.

24. A welding mask according to claim 21, wherein said opaque translucent material substantially blocks light wavelengths <400 nm and >700 nm.

25. A welding mask according to claim 21, wherein said opaque translucent material is coated with a solar deflector material.

26. A welding mask assembly according to claim 21, wherein said opaque material comprises a tinted polymeric material.

27. A welding mask assembly according to claim 21, wherein said auxiliary outer protective mask comprises transparent material.

28. A welding mask assembly according claim 21, wherein said auxiliary outer protective mask is pivotally mounted to said principle mask.

29. A welding mask assembly according to claim 28, wherein said principle mask comprises lateral sides having mountings elements, said auxiliary outer mask comprising lateral sides having mounting elements, said principle mask mounting elements being pivotally mounted to said auxiliary outer mask mounting elements.

30. A welding mask assembly comprising:
a principle mask comprising a face shield for at least partially covering the face of a user, said face shield comprising a viewing portion thereof, said viewing portion comprising opaque translucent material, wherein said opaque material provides for high-intensity visible light associated with welding to be visible therethrough; and
an auxiliary inner protective mask mounted to the underside of said principle mask.

31. A welding mask assembly according to claim 30, further comprising an auxiliary outer protective mask mounted to the on said principle mask.

32. A welding mask assembly according to claim 30, wherein said high-intensity visible light associated with welding comprises a light having a wavelength from about 400 nm to about 700 nm.

33. A welding mask according to claim 30, wherein said opaque translucent material substantially blocks light wavelengths <400 nm and >700 nm.

34. A welding mask according to claim 30, wherein said opaque translucent material is coated with a solar deflector material.

35. A welding mask assembly according to claim 30, wherein said opaque material comprises a tinted polymeric material.

36. A welding mask assembly according to claim 30, wherein said auxiliary inner mask comprises transparent material.

37. A welding mask assembly according claim 30, wherein said auxiliary inner mask is pivotally mounted to said principle mask.

38. A welding mask assembly according to claim 37, wherein said principle mask comprises lateral sides having mountings elements, said auxiliary inner mask comprising lateral sides having mounting elements, said principle mask mounting elements being pivotally mounted to said auxiliary inner mask mounting elements.
